(19) United States
(12) Patent Application Publication
(10) Pub. No.: US 2011/0156603 A1
(43) Pub. Date: Jun. 30, 2011

(54) LIGHT-EMITTING DIODE DRIVING CIRCUIT

(75) Inventors: Chien-Ming KO, Hsin-Chu (TW); Yueh-Han Li, Hsin-Chu (TW); Sheng-Kai Hsu, Hsin-Chu (TW); Hung-Ching Lee, Hsin-Chu (TW)

(73) Assignee: AU OPTRONICS CORP., Hsinchu (TW)

(21) Appl. No.: 12/952,607

(22) Filed: Nov. 23, 2010

(30) Foreign Application Priority Data
Dec. 30, 2009 (TW) 098145927

(51) Int. Cl. H05B 37/02

(52) U.S. Cl. 315/185 R

(57) ABSTRACT

An exemplary light-emitting diode (LED) driving circuit includes a LED driving IC, at least a LED string and at least a resistor. The LED string each is electrically coupled between a power source voltage and a control terminal of the LED driving IC and whereby a driving current of the LED string is subjected to the control of the LED driving IC. The resistor each is electrically coupled to between the control terminal and a predetermined potential. Moreover, a LED driving method also is provided.

### BACKGROUND

1. Technical Field

The present invention relates to a light-emitting diode (LED) driving field, and particularly to a LED driving circuit and a LED driving method.

2. Description of the Related Art

Referring to FIG. 1, which is a schematic view of a conventional LED driving circuit. As shown in FIG. 1, the LED driving circuit 10 includes a LED driving integrated circuit (IC) 12, a plurality of LED groups/strings 14 and a plurality of transistors 16.

The LED driving IC 12 has a plurality of control pins 121 configured as control terminals of driving currents of the respective LED strings 14 and controls the driving currents of the LED strings 14 using a pulse-width modulation (PWM) driving manner. A terminal of each of the LED strings 14 is electrically coupled to a power source voltage VDD, and another terminal thereof is electrically coupled to a corresponding one of the control pins 121 of the LED driving IC 12 through a transistor 16 which is coupled with the LED string 14 in series; where the ON/OFF states of the transistor 16 are determined by a gate control signal Vg. Furthermore, each of the LED strings 14 includes a plurality of LEDs 141 electrically coupled to one another in series. Since the LEDs 141 are driven by forward-biased voltages, and thus the changes of driving currents would influence cross-voltages of the respective LEDs 141. Herein, the cross-voltage generally is a voltage difference between positive and negative electrodes of each the LED 141.

During the LED driving IC 12 driving the LED strings 14 by the PWM driving manner, the cross-voltage of each of the LEDs 141 in an off-cycle of a PWM signal V_{PWM} will fall compared with that in an on-cycle of the PWM signal V_{PWM}, such that voltage drops on the respective control pins 121 of the LED driving IC 12 are increased. At this moment, the gate control signal Vg will turn off the transistor 16, to avoid damaging the LED driving IC 12 resulting from the control pins 121 cannot bear the excessive high voltage drops.

The conventional technology employs the transistor 16 electrically coupled with each of the LED groups 12 in series to perform a voltage-dividing operation for avoiding damaging the LED driving IC 12 resulting from the control pins 121 cannot bear the excessive high voltage drops (i.e., the control pins 121 without quite enough voltage tolerance). However, the conventional technology will increase the cost of the LED driving circuit 10 because of including the transistors 16.

### BRIEF SUMMARY

Accordingly, the present invention relates to a light-emitting diode (LED) driving circuit which can avoid the damage of a LED driving integrated circuit (IC) thereof resulting from a control terminal(s) of the LED driving IC without quite enough voltage tolerance and further have a relatively low cost, to solve the problem of the prior art.

The present invention further relates to a LED driving method.

A LED driving circuit in accordance with an exemplary embodiment of the present invention includes a LED driving IC, at least one LED string and at least one resistor. The LED string each is electrically coupled between a power source voltage and a control terminal of the LED driving IC and thereby a driving current thereof is subjected to the control of the LED driving IC. The resistor each is electrically coupled between the control terminal of the LED driving IC and a predetermined potential. The LED string may include a plurality of semiconductor LEDs electrically coupled in series or a plurality of organic LEDs electrically coupled in series instead.

In an exemplary embodiment of the present invention, the LED driving circuit further includes a boost circuit electrically coupled between the LED driving IC and the power source voltage and configured for performing a boost operation to generate the power source voltage according to an input voltage thereof.

In an exemplary embodiment of the present invention, the LED driving IC includes a pulse-width modulation (PWM) circuit configured for controlling a driving current of each the LED string.

In an exemplary embodiment of the present invention, the LED driving circuit includes a plurality of the LED strings and a plurality of the resistors, and the LED driving IC includes a plurality of the control terminals, each of the LED strings is electrically coupled between a corresponding one of the control terminals and the power source voltage, and each of the resistors is electrically coupled between the corresponding one of the control terminals and the predetermined potential.

A LED driving method in accordance with an exemplary embodiment of the present invention is configured for driving a LED string. The LED driving method includes steps of: electrically coupling the LED string between a power source voltage and a LED driving IC so as to employ the LED driving IC to drive the LED string; electrically coupling a first terminal of a resistor to a node between the LED string and the LED driving IC, and electrically coupling a second terminal of the resistor to a predetermined potential; and setting a resistance value of the resistor to make a potential at the first terminal of the resistor lower than a threshold value when the LED string is turned off. The LED driving IC generally drives the LED string by a PWM driving mode/manner.

In an exemplary embodiment of the present invention, the step of setting the resistance value of the resistor to make the potential of the first terminal of the resistor lower than the threshold value when the LED string is turned off includes: selecting a forward cross-voltage of each of LEDs in the LED string when the LED string is turned off according to the power source voltage and the threshold value; obtaining a forward current of each of the LEDs corresponding to the forward cross-voltage of the LED; and calculating the resistance value of the resistor according to the power source voltage, the forward cross-voltages and the forward currents.

The exemplary embodiment of the present invention employs the resistor with suitable resistance value electrically between a node between the LED string and the control terminal of the LED driving IC and the predetermined potential, so that the resistor has a specific micro-current flowing therethrough during the off-cycle of the PWM signal, such micro-current does not influence the whole luminance of the LED string but can make the LED string maintain at a specific cross-voltage. Accordingly, the voltage on each the control terminal of the LED driving IC would not be excessively large and thus can protect the control terminal of the LED driving IC. In addition, the exemplary embodiment of the present invention employs the resistor to achieve the advantage of the transistor in the prior art, thus it has a relatively low cost.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view of a conventional LED driving circuit.

FIG. 2 is a schematic view of a LED driving circuit in accordance with an exemplary embodiment of the present invention.

FIG. 3 is a schematic view of a current-voltage characteristic curve of a LED in accordance with an exemplary embodiment of the present invention.

### DETAILED DESCRIPTION

Reference will now be made to the drawings to describe exemplary embodiments of the present light-emitting diode (LED) driving circuit and LED driving method in detail. The following description is given by way of example, and not limitation.

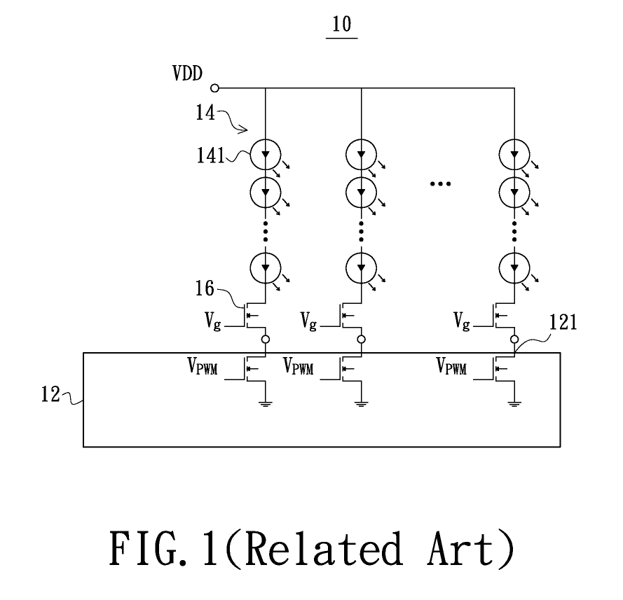

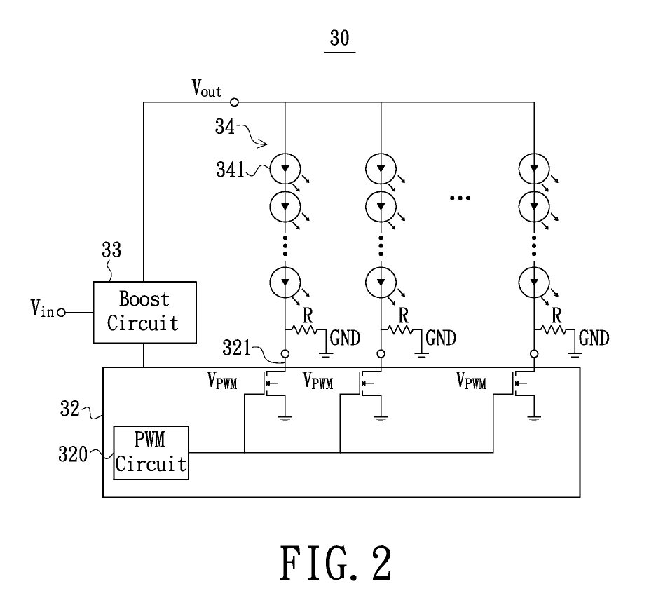

Referring to FIG. 1, which is a schematic view of a LED driving circuit in accordance with an exemplary embodiment of the present invention. As shown in FIG. 2, the LED driving circuit 30 includes a LED driving integrated circuit (IC) 32, a boost circuit 33, a plurality of LED strings 34 and a plurality of resistors R.

The LED driving IC 32 includes a plurality of control pins 321. Furthermore, in this exemplary embodiment, the LED driving IC 32 further includes a pulse-width modulation (PWM) circuit 320 to drive each of the LED strings 34 by a PWM driving mode. The PWM circuit 320 provides a plurality of PWM signals V_{PWM} respectively to a plurality of transistors which are electrically coupled with the respective control pins 321, to switch ON/OFF states of each of the transistors. The control pins 321 respectively are used as control terminals of the LED driving IC 32 for controlling driving currents of the respective LED strings 34. It should be noted that, although all of the PWM signals V_{PWM} as shown in FIG. 2 are electrically coupled with each other together, it does not represent all of the transistors must be driven by a same PWM signal V_{PWM}. The PWM signals V_{PWM} configured for driving the transistors respectively may be a same PWM signal, or be a plurality of PWM signals. The amount of the PWM signals may be determined by the need of the design, and thus can be adjusted.

The boost circuit 33 is electrically coupled to the LED driving IC 32. An input terminal of the boost circuit 33 is electrically coupled to receive an input voltage Vᵢₙ. The boost circuit 33 performs a boost operation applied to the input voltage Vᵢₙ to generate an output voltage Vₒᵤₜ and output the output voltage Vₒᵤₜ as a power source voltage of each of the LED strings 34.

One terminal of each of the LED strings 34 is electrically coupled to the output terminal of the boost circuit 38 to receive the power source voltage Vₒᵤₜ, and another terminal thereof is electrically coupled to a corresponding one of the control pins 321 of the LED driving IC 32. Herein, each of the LED strings 34 includes a plurality of LEDs 341 electrically coupled with one another in series, and each of the LEDs is driven by a forward-biased voltage. Thus a driving current flowing through each of the LEDs will influence the forward cross-voltage of the LED. In other words, the cross-voltage of each of the LEDs 341 electrically coupled in series in any one of the LED strings 34 in an off-cycle of the PWM signal V_{PWM} is lower than another cross-voltage of the LED 341 in an on-cycle of the PWM signal V_{PWM}. Therefore, in the off-cycle of the PWM signal V_{PWM}, the voltage drop of each of the control pins 321 of the LED driving IC 32 will be larger.

One terminal of each of the resistors R is electrically coupled between a corresponding one of the LED strings 341 and a corresponding one of the control pins 321 of the LED driving IC 32, and another terminal thereof is electrically coupled to a predetermined potential such as a ground potential GND and other suitable power source potential.

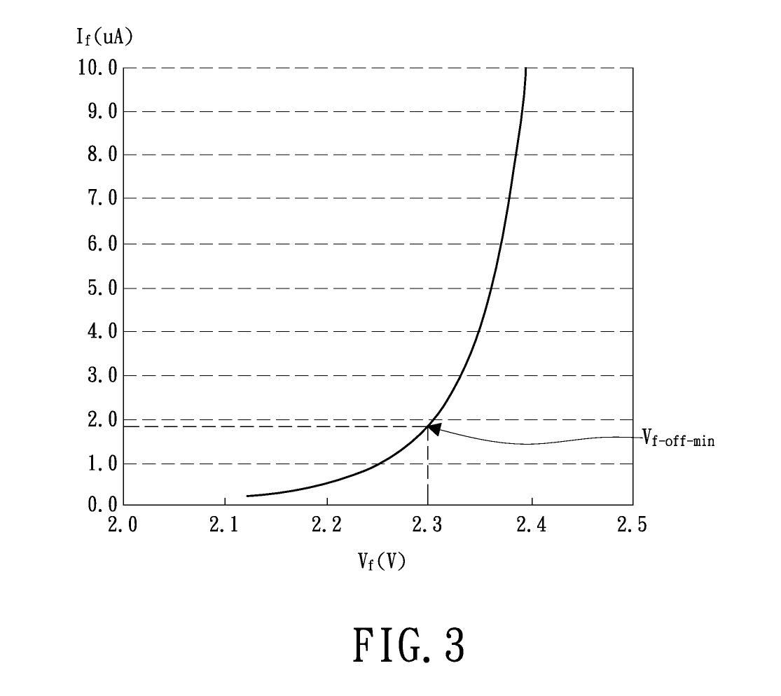

The following description will, cooperating with FIG. 3, describe how to set the resistance value of each of the resistors R to protect the control pins 321 of the LED driving IC 32 in the exemplary embodiment. FIG. 3 shows a current-voltage (I-V) characteristic curve of any one of the LEDs 341, the horizontal axis represents a forward cross-voltage V_{f} (its unit is volt (V)), and the longitudinal axis represents a forward current I_{f} (its unit is micro-ampere (uA)). In addition, since the exemplary embodiment employs a same method to determine the resistance value of each of the resistors R, the following description will only employ any one of the LED strings 34 as an example to describe the present embodiment.

For the convenience of description, it may assume the amount of the LEDs 341 of the LED string 34 is N and each of the LEDs 341 has the same I-V characteristic curve, and it defines each of the control pins 321 of the LED driving IC 32 has a voltage-tolerance threshold value Vₜₕ, a specific forward cross-voltage of each of the LEDs 341 electrically coupled in series of the LED string 34 is V_{f-off-min} when the LED string 34 is turned off (that is, in the off-cycle of the PWM signal V_{PWM}), and a specific micro-current passing through the LED string 34 is I in the off-cycle of the PWM signal V_{PWM}. For effectively avoiding damaging the control pin 321 of the LED driving IC 32, it will satisfy following conditions (1) and (2):

(Vₒᵤₜ−N×V_{f-off-min})<Vₜₕ (1)

R=(Vₒᵤₜ−N×V_{f-off-min})/I (2)

The resistance value of the resistor R may be determined by the following method. In the situation of the power source voltage Vₒᵤₜ and the voltage-tolerance threshold value Vₜₕ are known, the value of the specific forward cross-voltage V_{f-off-min} of each of the LEDs 341 can be determined according to the condition (1). Then the value of the specific micro-current I corresponding to the specific forward cross-voltage V_{f-off-min} may be obtained according to the I-V characteristic curve as shown in FIG. 3 (for example, as shown in FIG. 3, when V_{f-off-min} is 2.3V, the specific micro-current I is approximately equal to 1.8 uA). Afterwards, the value of the resistor R is calculated out according to the condition (2). It should be noted that, the specific micro-current I is the forward current which would not influence the whole luminance of the LED string 34 in the off-cycle of the PWM signal V_{PWM}.

Herein, the present invention employs the resistors R with suitable resistance value, thus the cross-voltage of each of the LED strings 34 in the off-cycle of the PWM signal V_{PWM} is increased with respect to that in the prior art without the resistors R. Therefore the voltage of each of the control pins 321 of the LED driving IC 32 in the off-cycle of the PWM signal V_{PWM} is correspondingly decreased below the voltage-tolerance threshold value Vₜₕ, and thus the purpose of protecting each of the control pins 321 is achieved.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A light-emitting diode (LED) driving circuit, comprising:
a LED driving integrated circuit (IC) comprising at least a control terminal;
at least a LED string each electrically coupled between an power source voltage and a corresponding one of the at least a control terminal; and
at least a resistor each electrically coupled between the corresponding one of the at least a control terminal and a predetermined potential.

2. The LED driving circuit as claimed in claim 1, further comprising:
a boost circuit electrically coupled between the LED driving IC and the power source voltage and configured for performing a boost operation to generate the power source voltage according to an input voltage thereof.

3. The LED driving circuit as claimed in claim 1, wherein the LED driving IC comprises:
a pulse-width modulation (PWM) circuit configured for controlling a driving current of each of the at least a LED string.

4. The LED driving circuit as claimed in claim 1, wherein an amount of the at least a LED string is multiple, and amounts of the at least a control terminal and the at least a resistor both are multiple, each of the LED strings is electrically coupled between the corresponding one of the control terminals and the power source voltage, and each of the resistors is electrically coupled between the corresponding one of the control terminals and the predetermined potential.

5. The LED driving circuit as claimed in claim 1, wherein the at least a LED string each comprises a plurality of semiconductor LEDs electrically coupled in series.

6. The LED driving circuit as claimed in claim 1, wherein the at least a LED string each comprises a plurality of organic LEDs electrically coupled in series.

7. A LED driving method configured for driving a LED string, and the LED driving method comprising steps of:
electrically coupling the LED string between a power source voltage and a LED driving IC;
electrically coupling a first terminal of a resistor between the LED string and the LED driving IC, and electrically coupling a second terminal of the resistor to a predetermined potential; and
setting a resistance value of the resistor to make a potential at the first terminal of the resistor lower than a threshold value when the LED string is turned off.

8. The LED driving method as claimed in claim 7, wherein when the LED string comprises a plurality of LEDs electrically coupled in series, and the step of setting the resistance value of the resistor to make the potential of the first terminal of the resistor lower than the threshold value when the LED string is turned off comprises:
selecting a forward cross-voltage of each of the LEDs when the LED string is turned off according to the power source voltage and the threshold value;
obtaining a forward current of each the LEDs corresponding to the forward cross-voltage of the LED; and
calculating the resistance value of the resistor according to the power source voltage, the forward cross-voltages and the forward currents.

9. The LED driving method as claimed in claim 7, further comprising:
enabling the LED driving IC to drive the LED string by a PWM driving mode.
